(19) United States
(12) Patent Application Publication
(10) Pub. No.: US 2016/0267466 A1
(43) Pub. Date: Sep. 15, 2016

(54) DEVICE WITH MULTIPLE IDENTIFIERS

(71) Applicants: Phillip Kumnick, Phoenix, AZ (US); Mark Allen Nelsen, Oakland, CA (US); John F. Sheets, San Francisco, CA (US)

(72) Inventors: Phillip Kumnick, Phoenix, AZ (US); Mark Allen Nelsen, Oakland, CA (US); John F. Sheets, San Francisco, CA (US)

(21) Appl. No.: 15/068,408

(22) Filed: Mar. 11, 2016

Related U.S. Application Data
(60) Provisional application No. 62/133,225, filed on Mar. 13, 2015.

(51) Int. Cl. G06Q 20/34; G06Q 20/32; G06Q 20/40; G06Q 20/36

(52) U.S. Cl. CPC G06Q 20/341; G06Q 20/367; G06Q 20/3572; G06Q 20/3227; G06Q 20/3674; G06Q 20/401; G06Q 20/409

(57) ABSTRACT

A device stores multiple identifiers meant for specific uses. For example, multiple transaction tokens can reside on different parts of a user device. Each transaction token can be compatible for use with a transaction channel (e.g., contact, contactless, and card-not-present, telephone-order, mail-order, in-app, etc.). A transaction can be terminated based on a transaction token being utilized in an inappropriate transaction channel, which limits the chances that a compromised transaction token can be successfully utilized for fraud. In some cases, the user device may be a transaction card or a mobile phone.

### CROSS-REFERENCES TO RELATED APPLICATIONS

This application is a non-provisional of and claims the benefit of priority to U.S. Provisional Application No. 62/133,225, filed Mar. 13, 2015, which is hereby incorporated by reference in its entirety for all purposes.

### BACKGROUND

In typical transactions, a user may present account information associated with their account. For example, a user may present account information by using a payment device associated with their payment account during a transaction. The account information typically includes an account identifier, such as an account number or token, that can be utilized to conduct transactions using the user's payment account. The account information may be exposed to various entities involved in processing a transaction. For example, the account information may be passed from a point-of-sale terminal to a resource provider system associated with a resource provider, an acquirer system, payment processing network, and other entities.

In some cases, such account information can be vulnerable. For example, while the account information is passed to multiple entities over a network, the account information may be intercepted by a malicious party and may subsequently be utilized to conduct fraudulent transactions. In another example, account information may be directly copied from the payment device, such as from a magnetic stripe on a payment card, and subsequently be utilized to conduct fraudulent transactions. It can be risky to have account information compromised because the compromised account information is susceptible to being utilized for fraud across different transaction types. For example, account information stolen during a card-present terminal may be utilized to conduct fraudulent transactions in a card-not-present transaction by a remote fraudulent entity.

Embodiments of the invention address this and other problems, individually and collectively.

### BRIEF SUMMARY

Some embodiments of the present invention relate to systems and methods for enabling multiple identifiers on a device, where each identifier is meant for a specific use.

Embodiments of the invention relate to a user device. The user device may comprise a substrate, a first memory unit coupled to the substrate, and a second memory unit coupled to the substrate. The first memory unit may comprise a first transaction token to be utilized in a first transaction channel and associated with an account identifier for an account of a user. The second memory unit may comprise a second transaction token to be utilized in a second transaction channel and associated with the account identifier for the account of the user. In some cases, the first transaction channel and the second transaction channel may be distinct.

In some embodiments, the user device can comprise a third transaction token. The third transaction token can be associated with the account identifier for the account of the user displayed on the substrate to be utilized in a third transaction channel. In some cases, the third transaction channel may be distinct from the first and second transaction channels. For example, the third transaction channel may be a card-not-present transaction channel. In other embodiments, the user device can display the account identifier for the account of the user on the substrate instead of the third transaction token.

In some embodiments, the user device can be a transaction card. The transaction card may comprise the first memory unit, which can be a magnetic stripe, to be utilized in the first transaction channel, which can be a contact transaction channel. The transaction card may further comprise the second memory unit, which can be a memory chip on the card to be utilized in the second transaction channel, which can be a contactless transaction channel.

In other embodiments, the user device can be a mobile phone. The mobile phone can comprise the first memory unit comprising the first transaction token to be utilized in the first transaction channel, which may be an in-app transaction channel. The mobile phone can further comprise the second memory unit comprising the second transaction token to be utilized in the second transaction channel, which may be a contactless transaction channel.

Embodiments of the invention relate to a method. The method may be performed by a server computer. The method may comprise receiving a first authorization request message including the first transaction token. The receiving step may be performed after a user initiates a first transaction using a user device comprising a first memory unit comprising a first transaction token and a second memory unit comprising a second transaction token. The first and second transaction tokens may be associated with an account identifier for an account of the user. The method may further comprise determining that the first transaction token was utilized in a first transaction channel and sending an indication that the first transaction token is verified with the first authorization request message. The method may further comprise, after the user initiates a second transaction using the user device, receiving a second authorization request message including the second transaction token. The method may further comprise determining that the second transaction token was utilized in a second transaction channel, wherein the first and second transaction channels are distinct, and sending an indication that the second transaction token is verified with the second authorization request message.

Embodiments of the invention further relate to a server computer. The server computer may comprise a processor and a computer-readable medium. The computer-readable medium may comprise code, executable by the processor, for performing the method described above.

These and other embodiments of the invention are described in further detail below.

### BRIEF DESCRIPTION OF THE DRAWINGS

FIG. 1 shows an exploded view of an exemplary user device as a transaction card according to embodiments of the present invention.

FIG. 2 shows an exemplary user device as a mobile phone according to embodiments of the present invention.

FIG. 3 shows a block diagram of a system according to embodiments of the present invention.

FIG. 4 shows a block diagram of an exemplary processing network according to embodiments of the present invention.

FIG. 5 shows an exemplary flow diagram for processing a transaction according to embodiments of the present invention.

FIG. 6 shows an exemplary flow diagram for processing a transaction according to embodiments of the present invention.

FIG. 7 shows an exemplary authorization request message according to embodiments of the present invention.

### DETAILED DESCRIPTION

Some embodiments of the present invention relate to systems and methods for enabling multiple transaction tokens on a user device, where each transaction token is to be utilized in a specific transaction channel. The transaction tokens can be processed in a transaction conducted with the user device. In some embodiments, the user device may be a transaction card comprising multiple transaction tokens stored on different parts of the transaction card. For example, the transaction card may have a magnetic stripe comprising a first transaction token meant for a contact transaction channel, a memory chip comprising a second transaction token meant for a contactless transaction channel, and a displayed third payment token meant for an e-commerce transaction channel. In some embodiments, the user device may be a mobile phone comprising multiple transaction tokens. In some implementations, the transaction tokens are meant to be utilized in one or more transaction channels.

Before discussing specific embodiments and examples, some descriptions of terms used herein are provided below.

An “account identifier” may be any information that can be utilized to identify an account. In some embodiments, the account identifier may be an account number (e.g., primary account number (PAN)) associated with a user's payment account. Other exemplary account identifiers may be any user information, such as an alias (e.g., email address), name, and other information that may be unique to the user and is associated with the user's account.

A “token” may include a substitute identifier for some information. For example, a transaction token (e.g., payment token), may include an identifier for a payment account that is a substitute for an account identifier, such as a PAN. For instance, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing payment processing networks (e.g., ISO 8583 financial transaction message format). In some embodiments, a token may be used in place of a PAN to initiate, authorize, settle or resolve a payment transaction. The token may also be used to represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

A “transaction channel” may include a pathway or mode by which a transaction may be conducted. The transaction channel may indicate how transaction information is for the transaction is provided to an access device or resource provider computer. Exemplary transaction channels for a transaction conducted using a transaction card may include a contact transaction channel, a contactless transaction channel, an e-commerce transaction channel, a card-present transaction channel, a card-not-present transaction channel, a mail order transaction channel, and a telephone order transaction channel. Exemplary transaction channels for a transaction conducted using a mobile phone may include an in-app transaction channel and a contactless transaction channel. Other examples of transaction channels may utilize different communication modes or protocols including Bluetooth (BLE or classic), IR (infrared), mesh networks, Wi-Fi, etc.

An “authorization request message” may be an electronic message that is sent to a processing network (e.g. payment processing network) and/or an authorization computer (e.g., issuer computer) to request authorization for a transaction. An authorization request message according to some embodiments may comply with (International Organization of Standardization) ISO 8583, which is a standard for systems that exchange electronic transaction information associated with a transaction made by a user using a user device (e.g., payment device) or user account (e.g., payment account). The authorization request message may include an issuer account identifier that may be associated with the user device or user account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an authorizing entity (e.g., issuer, financial institution) or a processing network (e.g., payment processing network). The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the processing network) to the resource provider's access device (e.g. POS equipment) that indicates approval of the transaction. The code may serve as proof of authorization. As noted above, in some embodiments, a processing network may generate or forward the authorization response message to the resource provider computer.

A “resource provider” may be an entity that can provide a resource such as goods, services, information, and/or access. Examples of a resource provider include merchants, access devices, secure data access points, etc. In some cases, the resource provider may operate a physical store and utilize an access device for in-person transactions. The resource provider may also sell goods and/or services via a website, and may accept payments over the Internet.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue payment credentials stored on a user device, such as a cellular telephone, smart card, tablet, or laptop to the user.

A “server computer” may include a powerful computer or cluster of computers. For example, the server computer can be a large mainframe, a minicomputer cluster, or a group of servers functioning as a unit. In one example, the server computer may be a database server coupled to a Web server. A server computer may comprise one or more computational apparatuses and may use any of a variety of computing structures, arrangements, and compilations for servicing the requests from one or more client computers.

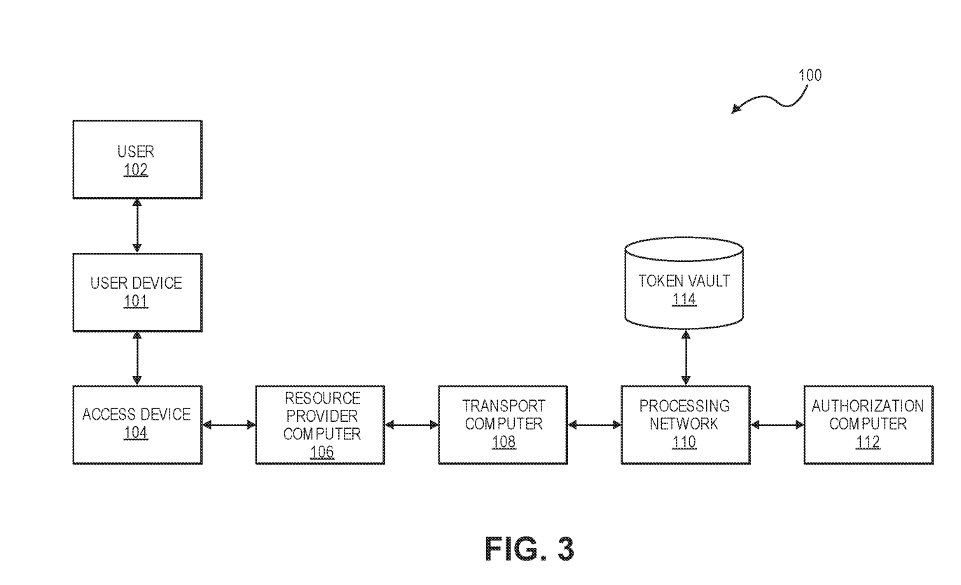

FIG. 3 illustrates an exemplary system 100 according to embodiments of the present invention. FIG. 3 includes a user 102, a user device 101, an access device 104, a resource provider computer 106 associated with a resource provider, a transport computer 108, a processing network 110, an authorization computer 112, and a token vault 114. Any of the devices and computers in FIG. 3 may be in operative communication with each other through any suitable communication channel or communications network.

User 102 may operate user device 101 and may conduct a transaction with a resource provider associated with resource provider computer 106. In some embodiments, user 102 may be physically present at a payment terminal of the resource provider associated with resource provider computer 106 and may conduct a card-present transaction utilizing user device 101 at access device 104. In other embodiments, user 102 may communicate with a resource provider computer 106 by a remote computer and conduct a card-not-present transaction (e.g., e-commerce transaction) utilizing user device 101.

User device 101 may be operated by user 102 and may be capable of communicating information with other devices according to embodiments of the invention. Some non-limiting examples of user device 102 may include mobile devices (e.g., cellular phones, keychain devices, personal digital assistants (PDAs), pagers, notebooks, laptops, notepads, wearable devices (e.g., smart watches, fitness bands, jewelry, etc.), automobiles with remote communication capabilities, personal computers, payment cards (e.g., smart cards, magnetic stripe cards, etc.), and the like.

In some embodiments, user device 101 may comprise multiple transaction tokens and may be utilized to conduct transactions. Each transaction token of user device 101 may be designated for use in one or more specific transaction channels. For example, user device 101 may be a transaction card comprising multiple transaction tokens stored on different parts of the card associated with different transaction channels (e.g., magnetic stripe associated with magnetic stripe transaction, contactless chip associated with contactless transaction, display on substrate associated with e-commerce transaction, etc.). In another example, user device 101 may be a mobile phone storing multiple transaction tokens associated with different transaction channels.

Access device 104 may be any suitable device that provides access to a remote system. In some cases, access device 104 may be any suitable device for communicating with a resource provider computer 106 or processing network 110, and for enabling interaction with user 102. Some non-limiting examples of the access device 104 may include POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. Access device 104 may use any suitable contact or contactless mode of operation to send or receive data from, or associated with, the user device 101. In some embodiments, access device 104 may be a client computer associated with the resource provider associated with resource provider computer 106.

In some embodiments, where access device 104 may comprise a POS terminal, any suitable POS terminal may be used and can include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device. In some embodiments, a cellular phone, tablet, or other dedicated wireless device used as a POS terminal may be referred to as a mobile point of sale or an “mPOS” terminal.

Access device 104 may also be used for communicating with other systems. For example, access device 104 may communicate with resource provider computer 106, transport computer 108, a processing network 110, authorization computer 112, or any other suitable system. Access device 104 may generally be located in any suitable location, such as at the location of a resource provider associated with resource provider computer 106. In some embodiments, access device 104 may receive data from user device 101 for a remote transaction (e.g., e-commerce transaction) and may forward the received data to an appropriate entity.

Resource provider computer 106 may be a device that is associated with a resource provider. The resource provider may engage in transactions, sell goods or services, or provide access to goods or services to the user associated with user device 102. Resource provider computer 106 may accept multiple forms of payment and may be associated with multiple tools to conduct different types of transactions. For example, resource provider computer 106 may be associated with access device 104 and communicate information to and from access device 104. In some cases, resource provider computer 106 may host a website associated with the resource provider through which the user may make a transaction. In some embodiments, resource provider computer 106 may also be able to request tokens associated with the user (e.g., payment tokens associated with user's payment credentials).

Transport computer 108 may be a device that may transmit information between entities. Transport computer 108 may be associated with resource provider computer 106, and may manage authorization requests on behalf of resource provider computer 106. Transport computer 108 may also handle token request messages on behalf of the resource provider computer 108. For example, in some embodiments, transport computer 108 may receive and forward token request messages in the same manner as authorization request messages. In some cases, transport computer 108 may be an acquirer computer associated with an acquirer.

Processing network 110 may include data processing subsystems, networks, and operations used to support and deliver authorization services, exception file services, and clearing and settlement services. For example, processing network 110 may comprise a server coupled to a network interface (e.g., by an external communication interface), and databases of information. In some cases, processing network 110 may be a transaction processing network (e.g., payment processing network). An exemplary processing network may include VisaNet™. Processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. Processing network 110 may use any suitable wired or wireless network, including the Internet. In some embodiments, processing network 110 may be in communication with token vault 114.

Token vault 114 may comprise any information related to tokens (e.g., payment tokens). In some cases, token vault 114 may be one or more databases. For example, token vault 114 may store tokens and a mapping of the tokens to their associated accounts. Token vault 114 may comprise any sensitive information (e.g., account number) associated with payment tokens. In some embodiments, payment processing network 110 may communicate with token vault 114 to de-tokenize a payment token. Token vault 114 may de-tokenize the payment token by determining information associated with the token based on the stored mapping. In some embodiments, token vault 114 may reside at processing network 110.

Authorization computer 112 may be a device associated with an authorizing entity. Authorization computer 112 may authorize an entity to conduct a transaction or to receive access to goods or services on behalf of the authorizing entity. In some cases, authorization computer 112 may receive and process an authorization request message, as well as generate and transmit an authorization response message. In some embodiments, authorization computer 112 may be an issuer computer. The issuer computer is typically a computer run by a business entity (e.g., a bank) that may have issued the payment (credit/debit) card, account numbers or payment tokens used for the transactions. Some issuer systems can perform both issuer computer and acquirer computer functions. When a transaction involves a payment account associated with the issuer computer, the issuer computer may verify the account and respond with an authorization response message to the transport computer that may be forwarded to the corresponding access device, if applicable.

In some cases, at a later time (e.g., at the end of the day), a clearing and settlement process can occur between transport computer 108, processing network 110, and authorization computer 112.

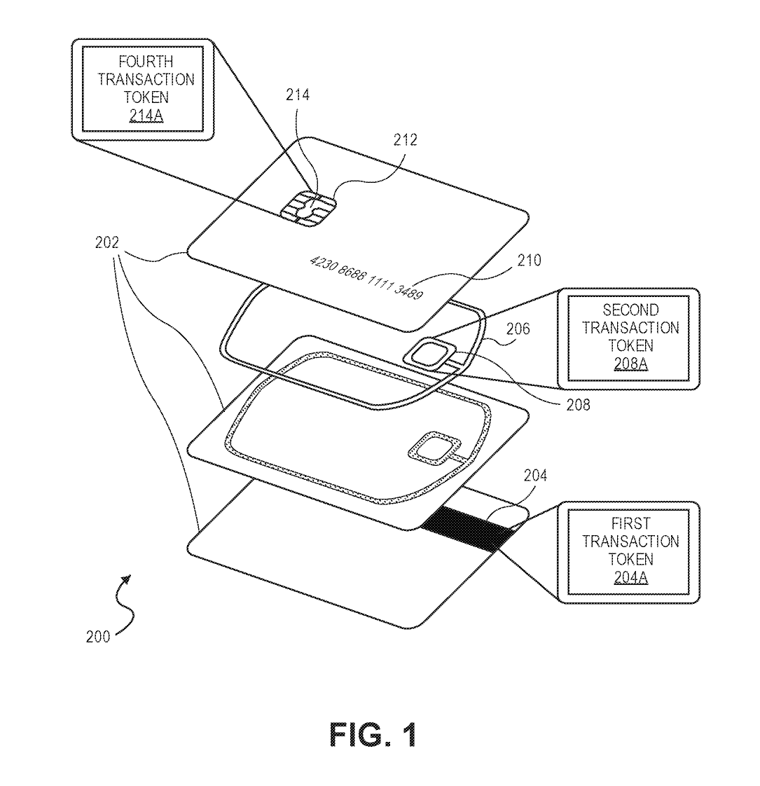

FIG. 1 shows an exploded view of an exemplary user device (e.g., user device 101 of FIG. 3) in the form of a transaction card 200 according to embodiments of the present invention. Transaction card 200 includes a substrate 202, a first memory unit 204 comprising a first transaction token 204A, a contactless element 206 comprising a second memory unit 208 including a second payment token 208A, a third transaction token 210 displayed on the substrate 202, and a contact interface 212 comprising a third memory unit 214 including a fourth transaction token 214A. The transaction tokens may be associated with an account of the user associated with transaction card 200.

FIG. 1 may be described with reference to elements of FIG. 3. In an exemplary case, user 102 may use transaction card 200 to conduct a transaction with a resource provider associated with resource provider computer 106.

In some embodiments, transaction card 200 may be a “smart card” or similar device, such as a credit or debit type card in which a chip is embedded. One form of such a device is known as an EMV (Europay™, MasterCard™, and Visa™) card. In the context of the present invention, EMV refers to a standard for interoperation of IC cards (“chip cards”) and IC card capable POS terminals and ATMs, and is used for authenticating credit and debit card payments. The EMV standard defines the interactions at the physical, electrical, data and application levels between IC cards and IC card processing devices for use in financial transactions. Substrate 202 may provide the form factor for transaction card 200. Transaction card 200 may have any suitable dimensions and may have a major surface shaped as a rectangle, and may be less than 6 inches by 4 inches.

Transaction card 200 may comprise first memory unit 204, which may be capable of storing first transaction token 204A that is meant to be utilized in a certain transaction channel. In some cases, first memory unit 204 may be a magnetic stripe, which may transfer data to another device, such as access device 104, when in contact with a magnetic stripe reader at a POS terminal associated with resource provider computer 106.

In some embodiments, first transaction token 204A may be meant to be utilized in a contact transaction channel. If user 102 conducts a contact transaction by swiping transaction card 200 at access device 104, then first transaction token 204A may be utilized to process the transaction. In some embodiments, first transaction token 204A may not be able to be utilized in other transaction channels besides the contact transaction channel. More specifically, in some cases, first transaction token 204A may not be able to be utilized in any transactions that are not magnetic-stripe transactions.

Transaction card 200 may comprise contactless element 206 including second memory unit 208, which may be capable of storing second transaction token 208A that is meant to be utilized in a certain transaction channel. In some embodiments, second memory unit 208 may be a chip or other form of data storage element. Contactless element 206 may enable the capability to communicate and transfer data from second memory unit 208 to another device, such as access device 104, using a near field communications (NFC) technology or other short range communications technology. In some cases, contactless element 206 may be an antenna that can read and write information to second memory unit 208. Contactless element 206 may be present on, or embedded within, substrate 202.

In some embodiments, second transaction token 208A may be meant to be utilized in a contactless transaction channel. If user 102 conducts a contactless transaction with transaction card 200 at access device 104, then second transaction token 208A may be utilized to process the transaction. In some embodiments, second transaction token 208A may not be able to be utilized in other transaction channels besides the contactless transaction channel.

Transaction card 200 may display third transaction token 210, which is meant to be utilized in a certain transaction channel, in any suitable manner. Third transaction token 210 may reside on any suitable area (e.g., front side, back side) of substrate 202 and may be visible during a transaction. In some embodiments, third transaction token 210 may be printed or embossed on transaction card 200. In other embodiments, third transaction token 210 may be displayed on a display embedded in transaction card 200.

In some embodiments, third transaction token 210 may be meant to be utilized in an e-commerce transaction channel. For example, user 102 may conduct an e-commerce transaction with transaction card 200 by key-entering third transaction token 210 into a webpage. If user 102 conducts an e-commerce transaction using transaction card 200, then third transaction token 210 may be utilized to process the transaction. User 102 may conduct the e-commerce transaction with any suitable computer capable of communicating with a resource provider computer 106 over a communications network. In some embodiments, third transaction token 210 may not be able to be utilized in other transaction channels besides the e-commerce transaction channel.

Transaction card 200 may also comprise contact interface 212 including third memory unit 214, which may be capable of storing fourth transaction token 214A that is meant to be utilized in a certain transaction channel. Third memory unit 214 may be a chip or other form of data storage element. Contact interface 212 may have contacts that enable the capability to communicate and transfer data to another device, such as access device 104, which includes contact chip-reading technology. Contact interface 212 may be present on, or embedded within, substrate 202.

In some embodiments, fourth transaction token 214A may be meant to be utilized in a contact transaction channel. For example, if user 102 conducts a transaction by dipping transaction card 200 into a chip reader of access device 104, then fourth transaction token 214A may be utilized to process the transaction. In some embodiments, fourth transaction token 214A may not be able to be utilized in other transaction channels besides the contact transaction channel. More specifically, in some cases, fourth transaction token 204A may not be able to be utilized in any transactions that are not conducted between contact interface 212 and a contact chip-reader on an access device.

As described above, each transaction token on transaction card 200 may be designated to be utilized in a specific transaction channel when user 102 is conducting a transaction. In some embodiments, attempting to utilize a transaction token of transaction card 200 in a transaction channel to which it is not designated to may result in an error and terminate the transaction.

It is noted that there may be certain exceptions regarding the transaction channels in which the transaction tokens of transaction card 200 may be utilized. For example, there may be a case in which first transaction token 204A, second transaction token 208A, and fourth transaction token 214A are not able to be processed during a card-present transaction. This situation may arise, for example, due to issues related to the POS terminal associated with resource provider computer 106. An issue may be that a data reader, such as access device 104, is incapable of reading data appropriately from transaction card 200, perhaps due to connectivity or hardware problems.

In this case, a clerk at the POS terminal may key-enter third transaction token 210 to process the transaction. An indication that third transaction token 210 is being utilized in a transaction channel to which it is not originally designated may be included in an authorization request message for the transaction by the resource provider. In some cases, resource provider computer 106 may verify the change in transaction channel (e.g., by a digital signature). Hence, other entities involved in processing the transaction, such as processing network 110, may be notified of the change in transaction channel, verify the change, and allow the transaction to be performed.

While an embodiment in which each transaction token is meant to be utilized in a single transaction channel is described above with respect to FIG. 1, embodiments are not so limited. In some cases, a transaction token may be designated for use in a plurality of transaction channels. For example, third transaction token 210 may be designated to be utilized in an e-commerce transaction channel, a telephone order transaction channel, and a mail order transaction channel. In some cases, other transaction tokens on transaction card 200 including first transaction token 204A, second transaction token 208A, and fourth transaction token 214A may not be designated to be utilized in these transaction channels.

While transaction card 200 is described above as displaying transaction token 210, embodiments are not so limited. For example, in some cases, transaction card 200 may instead display a real account identifier, such as an account number (e.g., PAN). User 102 may enter the real account identifier when conducting a transaction using a transaction channel associated with transaction card 200 (e.g., e-commerce transaction channel).

Additionally, while FIG. 1 shows transaction card 200 as a hybrid card comprising two or more chip technologies, embodiments are not so limited. For example, another implementation of transaction card 200 may be in the form of a dual-interface card, in which a single embedded chip may be accessed through contact and contactless interfaces. In this case, a transaction token may be stored in the single chip and be designated to be utilized for contactless transactions and contact chip transactions. In other embodiments, more than one transaction token may be stored on the single chip and each transaction token may be designated for use in a certain transaction channel. Transaction card 200 may also include a magnetic-stripe comprising a transaction token to be utilized in magnetic-stripe transactions.

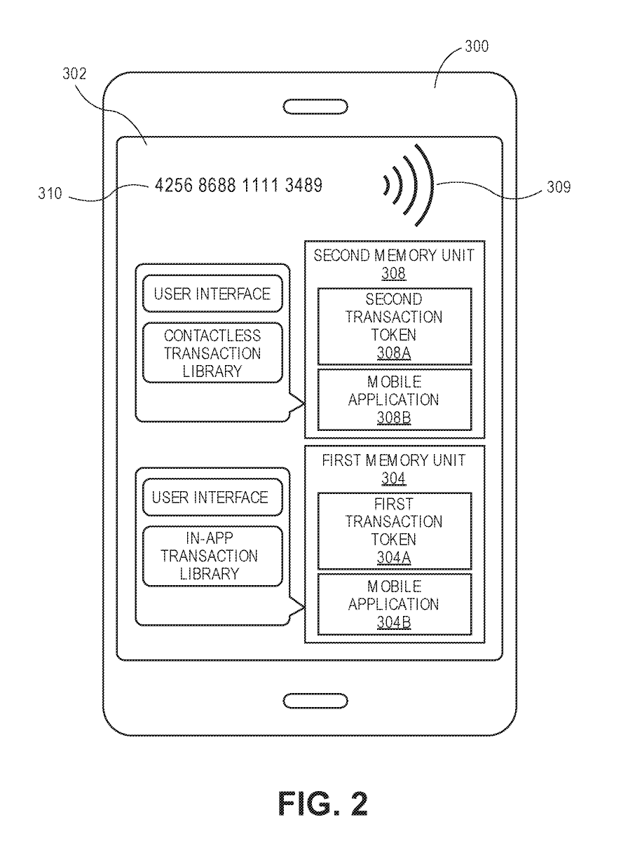

FIG. 2 shows an exemplary user device (e.g., user device 101 of FIG. 3) as mobile phone 300 according to embodiments of the present invention. Mobile phone 300 may include display 302 displaying a third transaction token 310, a first memory unit 304 comprising first transaction token 304A, and a second memory unit 308 comprising second transaction token 308A. In some embodiments, first memory unit 304 may comprise mobile application 304B and second memory unit 308 may comprise mobile application 308B. In some cases, mobile phone 300 may also include a contactless element 309. FIG. 2 may be described with reference to elements of FIG. 3. In an exemplary case, user 102 may use mobile phone 300 to conduct a transaction with a resource provider associated with resource provider computer 106.

Display 302 may be capable of showing information to user 102. For example, third transaction token 310 may be communicated to user 102 by being displayed on display 302. In some embodiments, user 102 may key-enter third transaction token 310 into a webpage when conducting an e-commerce transaction. In some cases, third transaction token 310 may be sent from a remote entity, such as processing network 110, and displayed on 302. In other embodiments, display 302 may display the real account number (e.g., PAN) instead of third transaction token 310.

First memory unit 304 may be any suitable form of data storage element compatible with mobile phone 300. For example, first memory unit 304 may be a data storage element that may store information related to mobile application 304B capable of conducting transactions from within mobile application 304B. Such transactions may be referred to “in app” purchases, where transactions can be conducted with a remote server (not depicted) associated with the application. Exemplary “in-app” purchases may include upgrades, resource provider application purchases, and any other transactions that may be conducted from within mobile application 304B. In some embodiments, mobile application 304B may comprise software that can provide a user interface and in-app purchase functionality enabled by an in-app transaction library. First memory unit 304 may comprise first transaction token 304A, which may be utilized to process transactions conducted from within mobile application 304B.

Second memory unit 308 may be any suitable form of data storage element compatible with mobile phone 300 and distinct from first memory unit 304. For example, second memory unit 308 may be a data storage element that may enable a transaction to be conducted with a contactless or wireless protocol (e.g., NFC, etc.). Second memory unit may store information related to mobile application 308B that can enable a transaction to be conducted with a contactless or wireless protocol (e.g., PayWave™). In some embodiments, mobile application 308B may comprise software that can provide a user interface and contactless transaction functionality enabled by a contactless transaction library. Second memory unit 308 may comprise second transaction token 308A, which may be utilized to process contactless or wireless transactions with mobile phone 300, in conjunction with contactless element 309 (e.g., antenna).

Each transaction token of mobile phone 300 may be designated to be utilized in a specific transaction channel when user 102 is conducting a transaction. In some embodiments, attempting to utilize a transaction token of mobile phone 300 in a transaction channel to which it is not designated may result in an error. The transaction may then be terminated.

While an embodiment in which each transaction token is meant to be utilized in a single transaction channel is described above with respect to FIG. 2, embodiments are not so limited. In some cases, a transaction token may be designated for use in a plurality of transaction channels. For example, third transaction token 310 may be designated to be utilized in an e-commerce transaction channel, a telephone order transaction channel, and a mail order transaction channel. In some cases, first transaction token 304A and second transaction token 308A may not be able to be utilized in these transaction channels.

Additionally, while FIG. 2 shows transaction tokens stored in separate memory units on mobile phone 300, embodiments are not so limited. In some cases, multiple transaction tokens may be stored on a single memory unit, where each transaction token may be designated for use in a separate transaction channel.

While embodiments of FIG. 1 and FIG. 2 describe transaction channels including in-app, contactless, contact, e-commerce, telephone-order, and mail order transaction channels, embodiments are not so limited. The transaction channels may include any suitable, distinct methods of conducting a transaction utilizing a transaction token of user device 101.

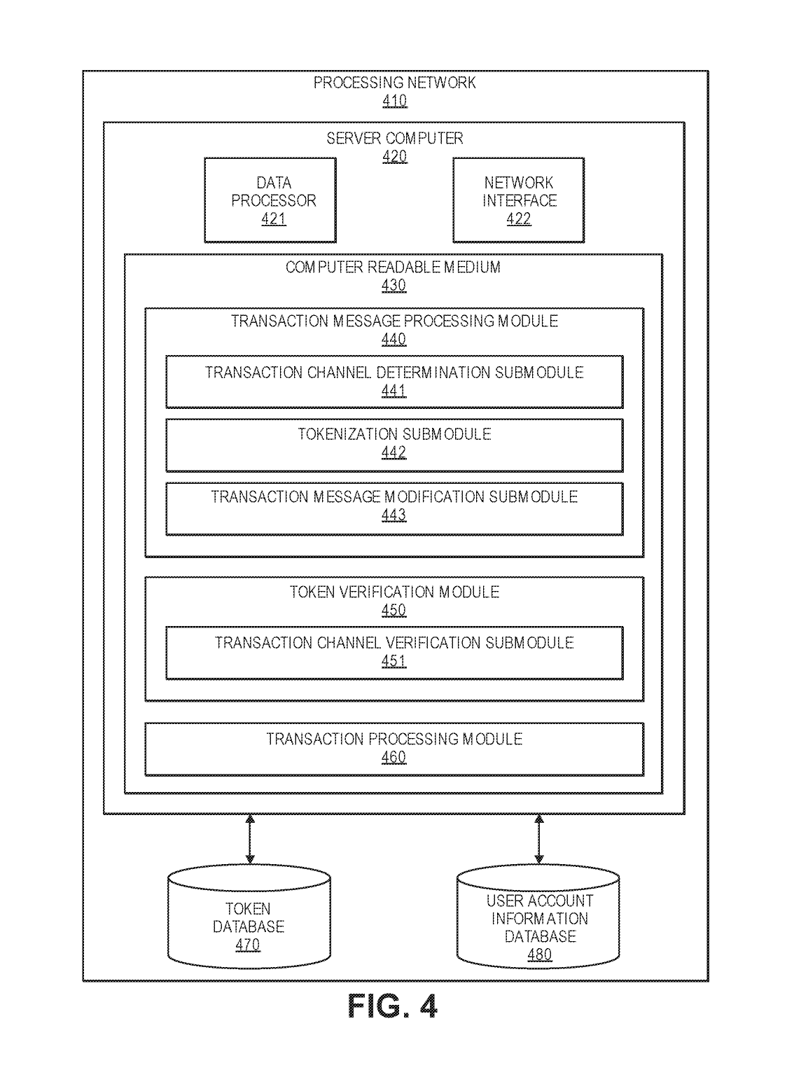

FIG. 4 shows a block diagram of an exemplary processing network 410 according to embodiments of the present invention. Processing network 410 includes a server computer 420 comprising a data processor 421, network interface 422, and a computer readable medium 430. The computer readable medium 430 may comprise a number of software modules including transaction message processing module 440, a token verification module 450, and a transaction processing module 460.

Other modules and submodules may also reside on the computer readable medium 430. Examples of additional modules may include an authorization module for processing and routing authorization request and response messages, a clearing and settlement module for processing and routing clearing messages and performing settlement between parties, and data extraction (e.g., for retrieving data from external data sources such as databases) modules, storage modules, and message modification modules. Each module in processing network 410 may be combined with any of the additional modules as appropriate. Each module in processing network 410 may comprise one or submodules, where each submodule may comprise one or more functions implemented by code, executable by data processor 421.

Processing network 410 may also comprise several databases, including a token information database 470 and a user account information database 480. Each database may be a conventional, fault tolerant, relational, scalable, secure database such as those commercially available from Oracle™ or Sybase™. In some embodiments, any of the databases may be combined into a single database, or may be separated into multiple databases. Processing network 410 may have other databases that are not shown in FIG. 4.

Data processor 421 (e.g., a microprocessor) may process functions of server computer 420. Data processor 421 may include hardware within user device 202 that can carry out instructions embodied as code in a computer-readable medium. Data processor 421 may be a central processing unit (CPU). As used herein, a processor can include a single-core processor, a plurality of single-core processors, a multi-core processor, a plurality of multi-core processors, or any other suitable combination of hardware configured to perform arithmetical, logical, and/or input/output operations of a computing device.

Network interface 422 may be any suitable combination of hardware and software that enables data to be transferred to and from processing network 410. Network interface 422 may enable processing network 410 to communicate data to and from another device (e.g., resource provider computer, transport computer, authorization computer, etc.). Some examples of network interface 422 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by network interface 422 may include Wi-Fi™.

Data transferred via network interface 422 may be in the form of signals which may be electrical, electromagnetic, optical, or any other signal capable of being received by the external communications interface (collectively referred to as “electronic signals” or “electronic messages”). These electronic messages that may comprise data or instructions may be provided between network interface 422 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

Transaction message processing module 440 may enable, with data processor 421, handling of transaction messages. In some embodiments, the transaction messages may be authorization request messages and authorization response messages generated for transactions conducted by a user. Transaction message processing module 440 may comprise transaction channel determination submodule 441, tokenization submodule 442, and transaction message modification submodule 443.

Transaction channel determination submodule 441 may determine, in conjunction with data processor 421, a transaction channel utilized to conduct a transaction. Transaction channel determination submodule 441 may receive, with data processor 421, an authorization request message for a transaction and may retrieve information from the authorization request message related to transaction channel. In some cases, the information may be an transaction channel identifier, such as a POS entry mode code, that indicates the transaction channel utilized for the transaction (e.g., manual key entry, contactless device read, etc.). Transaction channel determination submodule 441 may send, in conjunction with data processor 421, the determined transaction channel to token verification module 450, which can determine whether the determined transaction channel is appropriate.

Tokenization submodule 442 may enable, with data processor 421, tokenization and de-tokenization processes. In some embodiments, tokenization submodule 442 may conduct tokenization and de-tokenization processes for processing of authorization request messages and authorization response messages.

Tokenization submodule 442 may enable, in conjunction with data processor 421, a de-tokenization process for processing an authorization request message for a transaction. After receiving the authorization request message, tokenization submodule 442 may determine, with data processor 421, whether the authorization request message includes a transaction token. If the authorization request message does include a transaction token (e.g., payment token), tokenization submodule 442 may retrieve, with data processor 421, account information (e.g., PAN) associated with the token. In some cases, the token and associated account information may be stored in token database 470. In some cases, tokenization submodule 442 may send, with data processor 421, a request to transaction message modification submodule 443 to replace the transaction token with the account information in the authorization request message.

Tokenization submodule 442 may enable, in conjunction with data processor 421, a tokenization process for processing an authorization response message for a transaction. After receiving the authorization response message, tokenization submodule 442 may determine, with data processor 421, whether the authorization response message includes account information. Tokenization submodule 442 may retrieve, with data processor 421, the transaction token associated with the account information. In some cases, the transaction token and associated account information may be stored in token database 470. In some cases, tokenization submodule 442 may send, with data processor 421, a request to transaction message modification submodule 443 to replace the account information with the transaction token in the authorization response message. This may prevent other entities that process the authorization response message from obtaining sensitive account information associated with the user.

Transaction message modification submodule 443 may enable, in conjunction with data processor 421, updating of transaction messages. As described above, in some cases, transaction message modification submodule 443 may update, with data processor 421, an authorization request message to include account information instead of a transaction token and an authorization response message to include a transaction token instead of account information. Further, transaction message modification submodule 443 may update, in conjunction with data processor 421, the authorization request message to include an indication that a transaction token is verified and utilized in the appropriate transaction channel. In some embodiments, processing network 410 may conduct fraud analyses of a transaction and transaction message modification submodule 443 may update, with data processor 421, the authorization request message to include fraud analyses results.

Token verification module 450 may enable, in conjunction with data processor 421, determination of the validity of a token utilized in a transaction. In some embodiments, the determination may be made based on checking whether the transaction channel utilized to conduct the transaction is an appropriate transaction channel in which the transaction token was meant to be utilized. Token verification module 450 may comprise transaction channel verification submodule 451. While not shown in FIG. 4, token verification module 450 may comprise submodules that may enable, with data processor 421, other verification processes for tokens, such as transaction token assurance level determination.

Transaction channel verification submodule 451 may enable, in conjunction with data processor 421, determination of whether an appropriate transaction channel is utilized for a transaction. The determination may be performed in several ways.

In one embodiment, transaction channel verification submodule 451 may perform, with data processor 421, the determination using a transaction channel identifier. In some cases, the transaction channel identifier may be included in the authorization request message, where the transaction channel identifier indicates the transaction channel (e.g., contact, contactless, etc.) utilized for the transaction. In some cases, the transaction channel identifier may be a number that is mapped to the transaction channel (e.g., 2 for contact). In other cases, the transaction channel identifier may be made up of numeric, alphanumeric, or other characters. Transaction channel verification submodule 451 may then determine, with data processor 421, the transaction channel in which the token is meant to be utilized. In some cases, the transaction token may include an identifier indicating a transaction channel that can be utilized by the token. In one example, the transaction token may start with a number between 10 and 90, which may indicate that it is associated with a contact transaction. Transaction channel verification submodule 451 may then determine, with data processor 421, whether the transaction channel utilized for the transaction is the same as that meant to be utilized for the transaction token. If so, transaction channel verification submodule 451 may determine, with data processor 421, that the transaction token is being utilized in an appropriate transaction channel and send an indication indicating verification of the token to transaction message modification submodule 443.

In one embodiment, transaction channel verification submodule 451 may perform, with data processor 421, the determination using a cryptogram. In some cases, a cryptogram may be included in the authorization request message, where the cryptogram may be a verification value that can be generated dynamically for each transaction. In some cases, the cryptogram may be dependent on the transaction initiation method and may be associated with a certain transaction channel. Thus, the cryptogram may be utilized to determine whether the transaction token is being utilized in the designated transaction channel. For example, the transaction token designated for a contact transaction channel may be associated with a contact transaction channel cryptogram algorithm. If the cryptogram in the authorization request message cannot be validated based on the contact transaction channel cryptogram algorithm, the transaction may be declined. If the token can be validated based on the cryptogram, transaction channel verification submodule 451 may determine, with data processor 421, that the transaction token is being utilized in an appropriate transaction channel and send an indication indicating verification of the token to transaction message modification submodule 443.

Transaction processing module 460 may enable, with data processor 421, any processing related to conducting a transaction. Transaction processing module 333 may enable receiving, processing, and sending authorization request messages and authorization response messages. In some cases, transaction processing module 460 may store any transaction data retrieved during transaction processing in one or more databases, some of which may not be shown in FIG. 4, of processing network 410. In some cases, transaction processing module 460 may further handle clearing and settlement processing.

Token database 470 may include any information related to tokens. For example, token database 470 may have similar features to those of token vault 114 described for FIG. 3. In some embodiments, token database 470 may comprise data related to multiple user accounts. In such cases, token database 470 may store data organized by user account with each user account made differentiable by any suitable identifier (e.g., user account identifier). For each user account, token database 470 may store tokens (e.g., payment tokens) and data related to the tokens (e.g., designated transaction channel, assurance level, etc.) associated with the user account.

User account information database 480 may comprise any information related to user accounts. In some embodiments, user account information database 480 may comprise data related to multiple user accounts. In such cases, user account information database 480 may store data organized by user account with each user account made differentiable by any suitable identifier (e.g., user account identifier). For each user account, some examples of data that may be stored include a PAN, user identification information, transaction history, and other information.

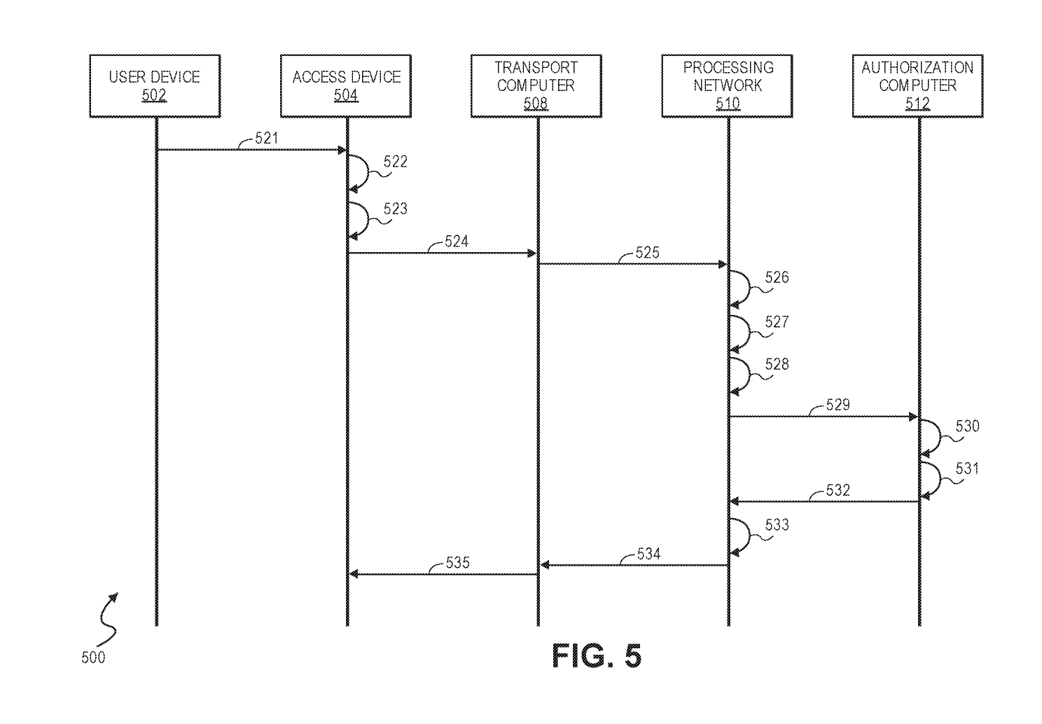

FIG. 5 shows an exemplary flowchart 500 for a method to process a transaction conducted by a user with a user device with multiple identifiers according to embodiments of the invention. FIG. 5 includes a user device 502, an access device 504, a transport computer 508, a processing network 510, and an authorization computer 512. Access device 504 may be associated with a resource provider with which the user conducts the transaction. In some embodiments, user device 502 may be a transaction card, such as transaction card 200 of FIG. 1. Some steps described in FIG. 5 may be described with respect to elements of FIG. 1.

Additional methods and processes may be included within these methods and may be recognized by one of ordinary skill in the art, in light of the description below. Further, in some embodiments of the present invention, the described methods may be combined, mixed, and matched, as one of ordinary skill would recognize.

At step 521, the user, utilizing user device 502, may initiate the transaction with the resource provider. In the exemplary transaction shown in FIG. 5, the user may be physically present at a POS terminal comprising access device 504 associated with the resource provider and thus may be conducting a card-present transaction.

At step 522, the user may utilize user device 502 to communicate transaction information to access device 504. The user may utilize any suitable payment method compatible with user device 502 and access device 504. For example, the user may want to conduct the transaction in a contact transaction channel at the POS terminal. Subsequently, access device 504 may read transaction information from a first memory unit of user device 502 using the contact transaction channel. The transaction information may be any data, such as a transaction token, that may be utilized to process the transaction. For example, the user may swipe user device 502 at access device 504, which may read first transaction token 204A from magnetic stripe 204. First transaction token 204A may also be an example of an identifier and may be associated with an account of the user.

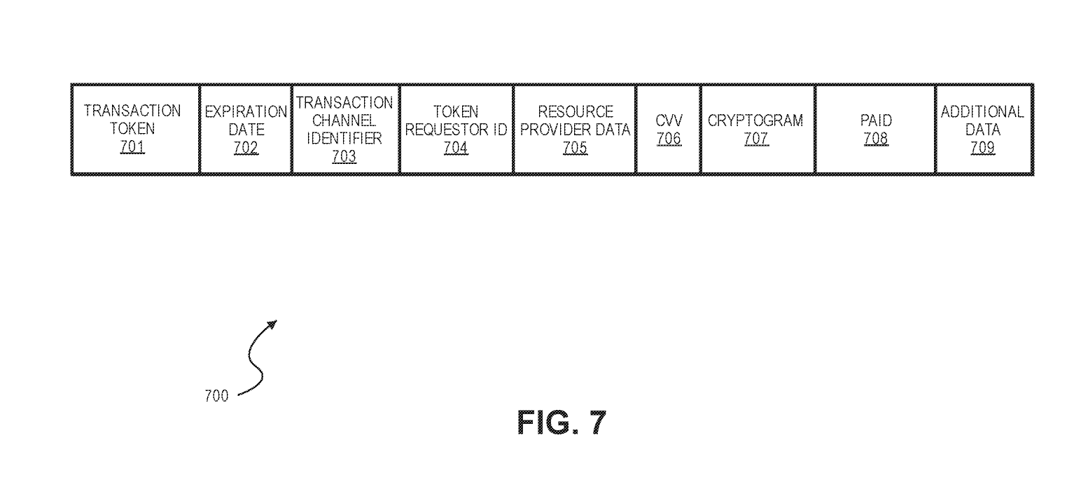

At step 523, access device 504 may generate an authorization request message for the transaction. The authorization request message may include first transaction token 204A received in step 522 so that other entities, such as processing network 510, may determine the account of the user to be utilized for the transaction. The authorization request message may also include information indicating the transaction channel utilized for the transaction. For example, the authorization request message may include a transaction channel identifier. The transaction channel identifier may be of any suitable format (e.g., numerical, alphanumerical, etc.) such that the transaction channel utilized for the transaction can be identified. Since the transaction is being conducted in the contact transaction channel, the authorization request message may include a transaction channel identifier associated with the contact transaction channel. In some cases, the transaction channel identifier may specifically indicate a magnetic-stripe transaction channel. Exemplary elements that may be included in an authorization request message may be described with respect to FIG. 7.

In some embodiments, a resource provider computer associated with the resource provider that hosts access device 504 may generate the authorization request message. In this case, access device 504 may forward the transaction information received from user device 502 to the resource provider computer over a suitable communications network.

At steps 524 and 525, the authorization request message may be transmitted from access device 504 to transport computer 508 and from transport computer 508 to processing network 510, respectively. The authorization request message may be communicated over any suitable communications network.

At step 526, processing network 510 may receive and process the authorization request message. Processing network 510 may determine the transaction channel in which the transaction is being conducted, as well as information related to the transaction token based on the received authorization request message. These pieces of information may be determined in parallel or in sequence.

Processing network 510 may determine the transaction channel utilized for the transaction based on a transaction channel identifier. As described above, the authorization request message may comprise the transaction channel identifier indicating the transaction channel utilized for the transaction. The transaction channel identifier may be of any suitable form (e.g., numeric, alphanumeric, etc.). Processing network 510 may retrieve the transaction channel identifier included in the authorization request message and determine the associated transaction channel. In some cases, the determination may be made based on a predefined mapping between transaction channel identifiers and associated transaction channels stored by processing network 510. The transaction channel identifier may indicate to processing network 510 that the transaction is being conducted using the contact transaction channel.

Processing network 510 may also determine the transaction channel in which the transaction token included in the authorization request message is meant to be utilized. In some embodiments, the transaction token may be configured to include an indicator of the transaction channel in which the transaction token is to be utilized. Processing network 510 may retrieve first transaction token 204A from the authorization request message and determine information stored in first transaction token 204A. In a simple example, first transaction token 204A may start with a number between 10 and 90, which may indicate that first transaction token 204A is designated to be utilized for a contact transaction. The mapping between information included in a transaction token and the associated designated transaction channel may be predefined and stored by processing network 510, such as in a database (e.g., token database 470 in FIG. 4).

At step 527, processing network 510 may verify whether the transaction token is being utilized in its designated transaction channel. In some cases, processing network 510 may compare the determined transaction channel being utilized for the transaction channel and the determined transaction channel meant to be utilized for the transaction token. If the determined transaction channels match, processing network 510 may determine that the transaction token is verified and is being utilized in the appropriate transaction channel. For example, processing network 510 may determine that first transaction token 204A is valid for the transaction because the transaction was conducted using the contact transaction channel and first transaction token 204A is meant to be utilized in the contact transaction channel. In some cases, if the determined transaction channels do not match, the transaction may be terminated at this point.

At step 528, processing network 510 may update the authorization request message. For example, processing network 510 may indicate to other entities whether first transaction token 204A is verified. In some embodiments, the verification result may be included as an indicator in the authorization request message. Additionally, processing network 510 may de-tokenize first transaction token 204A and replace it with real account information of the user in the authorization request message. This enables authorization computer 512 to identify the user's account to utilize for the transaction. In some cases, processing network 510 may access databases (e.g., token database 470 and user account information database 480 in FIG. 4) to determine account information, such as an account number (e.g., PAN) associated with first transaction token 204A and query the account information from the databases.

At step 529, processing network 510 may send the authorization request message to authorization computer 512. The authorization request message may be sent over any suitable communications network. The indicator indicating whether first transaction token 204A is verified may be sent with the authorization request message. In some cases, the indicator may be included in the authorization request message as described in step 528. In other cases, the indicator may not be included in the authorization request message and may be sent separately with the authorization request message.

At step 530, authorization computer 512 may determine whether the transaction may be authorized. In some embodiments, the determination may be made based on the indicator received indicating whether first transaction token 204A was verified by processing network 510. In some embodiments, authorization computer 512 may conduct further processing to determine whether the authorization transaction may be authorized. In some cases, authorization computer 512 may conduct fraud analyses on the user's account associated with the account number included in the authorization request message. The authorization computer 512 may also determine if there are sufficient funds or credit in the account to conduct the current transaction.

At step 531, authorization computer 512 may generate an authorization response message. The authorization response message may include the authorization result determined in step 530. In some cases, authorization computer 512 may also include information related to the conducted fraud analyses in the authorization response message.

At step 532, authorization computer 512 may send the authorization response message to processing network 510. The authorization response message may be sent over any suitable communications network.

At step 533, processing network 510 may receive and update the authorization response message. In some embodiments, processing network 510 may re-tokenize the account information included in the authorization response message. For example, processing network 510 may determine first transaction token 204A associated with the account information (e.g., PAN) and replace the account information with first transaction token 204A in the authorization response message. This enables real account information to be hidden from other entities (e.g., transport computer 508, the resource provider, access device 504) that process the authorization response message. In some cases, processing network 510 may access databases (e.g., token database 470 and user account information database 480 in FIG. 4) to determine first transaction token 204A associated with the account information and query first transaction token 204A from the databases.

At step 534 and 535, the authorization response message may be transmitted from processing network 510 to transport computer 508 and from transport computer 508 to access device 504, respectively. The authorization response message may be communicated over any suitable communications network. In some embodiments, the resource provider computer may receive the authorization response message from transport computer 508. The resource provider associated with access device 504 and the resource provider computer may determine whether to allow the transaction to continue based on the information in the received authorization response message. If the resource provider decides to approve the transaction, the transaction may be authorized and completed. A transaction amount associated with the transaction may eventually be debited from the user's account associated with first transaction token 204A. In some cases, a notification may be displayed by access device 504 or may be sent to user device 502 indicating whether the transaction was successfully completed.

In some cases, at a later time (e.g., at the end of the day), a clearing and settlement process can occur between transport computer 508, processing network 510, and authorization computer 512.

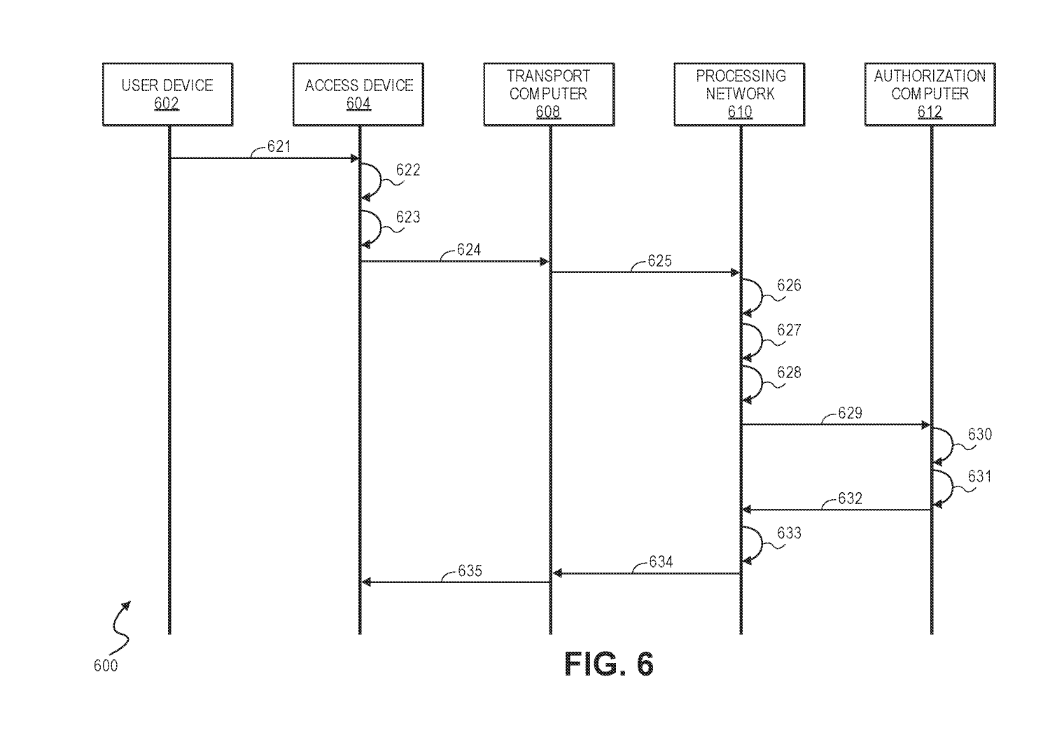

While an embodiment in which the transaction is conducted using a contact transaction channel (e.g., magnetic-stripe transaction) is described with respect to FIG. 5, user device 502 may be utilized for transactions in other transaction channels. For example, user device 502 may be utilized in a contactless transaction channel, in which second payment token 208A may be communicated to access device 504. In another case, user device 502 may be utilized in an e-commerce transaction channel, in which the user may key-enter third payment token 210 displayed on substrate 202 into a transaction data field of a payment webpage hosted by the resource provider. Payment processing network 510 may verify whether second payment token 208A and third payment token 210 are being utilized in an appropriate transaction channel. An exemplary second transaction conducted by the user is described with respect to FIG. 6.

FIG. 6 shows an exemplary flowchart 600 for a method to process a transaction conducted by a user with a user device with multiple identifiers according to embodiments of the invention. The transaction described with respect to FIG. 5 may be a first transaction and the transaction described with respect to FIG. 6 may be a second transaction. FIG. 6 includes a user device 602, an access device 604, a transport computer 608, a processing network 610, and an authorization computer 612. Any of these entities may be the same as those shown in FIG. 5 (user device 502, access device 504, transport computer 508, processing network 510, and authorization computer 512, respectively). For example, user device 602 may be the same device as user device 502 and may be associated with the user's account. User device 602 may be a transaction card, such as transaction card 200 of FIG. 1. Some steps described in FIG. 6 may be described with respect to elements of FIG. 1. Access device 604 may be associated with a resource provider with which the user conducts the transaction.

At step 621, the user, utilizing user device 602, may initiate the transaction with the resource provider. In the exemplary transaction shown in FIG. 6, the user may be physically present at a POS terminal comprising access device 604 associated with the resource provider and thus may be conducting a card-present transaction.

At step 622, the user may utilize user device 602 to communicate transaction information to access device 604. The user may utilize any suitable payment method compatible with user device 602 and access device 604. For example, the user may want to conduct the transaction in a contactless transaction channel at the POS terminal. The user may bring user device 602 in proximity with access device 604. Subsequently, access device 604 may read, using near field communication technology, transaction information from a second memory unit of user device 602 using the contactless transaction channel. The transaction information may be any data, such as a transaction token, that may be utilized to process the transaction. For example, access device 604 may read second transaction token 208A from second memory unit 208 (e.g., chip). Second transaction token 208A may also be an example of an identifier and may be associated with the account of the user. The account may be the same account utilized for the transaction described with respect to FIG. 5.

At step 623, access device 604 may generate an authorization request message for the transaction. The authorization request message may include second transaction token 208A received in step 622 so that other entities, such as processing network 610, may determine the account of the user to utilized for the transaction. The authorization request message may also include information indicating the transaction channel utilized for the transaction. For example, the authorization request message may include a transaction channel identifier. The transaction channel identifier may be of any suitable format (e.g., numerical, alphanumerical, string, etc.) such that the transaction channel utilized for the transaction can be identified. Since the transaction is being conducted using the contactless transaction channel, the authorization request message may include a transaction channel identifier associated with the contactless transaction channel. Exemplary elements that may be included in an authorization request message may be described with respect to FIG. 7.

In some embodiments, a resource provider computer associated with the resource provider that hosts access device 604 may generate the authorization request message. In this case, access device 604 may forward the transaction information received from user device 602 to the resource provider computer over a suitable communications network.

At steps 624 and 625, the authorization request message may be transmitted from access device 604 to transport computer 608 and from transport computer 608 to processing network 610, respectively. The authorization request message may be communicated over any suitable communications network.

At step 626, processing network 610 may receive and process the authorization request message. Processing network 610 may determine the transaction channel in which the transaction is being conducted, as well as information related to the transaction token based on the received authorization request message. These pieces of information may be determined in parallel or in sequence.

Processing network 610 may determine the transaction channel utilized for the transaction based on a transaction channel identifier. As described above, the authorization request message may comprise the transaction channel identifier indicating the transaction channel utilized for the transaction. The transaction channel identifier may be of any suitable form (e.g., numeric, alphanumeric, etc.). Processing network 610 may retrieve the transaction channel identifier included in the authorization request message and determine the associated transaction channel. In some cases, the determination may be made based on a predefined mapping between transaction channel identifiers and associated transaction channels stored by processing network 610. The transaction channel identifier may indicate to processing network 610 that the transaction is being conducted using the contactless transaction channel.

Processing network 610 may determine the transaction channel in which the transaction token in the authorization request message is meant to be utilized. In some embodiments, the transaction token may be configured to include an indicator of the transaction channel in which the transaction token is to be utilized. Processing network 610 may retrieve second transaction token 208A from the authorization request message and determine information indicating a transaction channel stored in second transaction token 208A. The mapping between information included in a transaction token and the associated designated transaction channel may be predefined and stored by processing network 610, such as in a database (e.g., token database 470 in FIG. 4).

At step 627, processing network 610 may verify whether the transaction token is being utilized in its designated transaction channel. In some cases, processing network 610 may compare the determined transaction channel being utilized for the transaction channel and the determined transaction channel meant to be utilized for the transaction token. If the determined transaction channels match, processing network 610 may determine that the transaction token is verified and is being utilized in the appropriate transaction channel. For example, processing network 610 may determine that second transaction token 208A is valid for the transaction because the transaction was conducted using the contactless transaction channel and second transaction token 208A is meant to be utilized in the contactless transaction channel. In some cases, if the determined transaction channels do not match, the transaction may be terminated at this point.

At step 628, processing network 610 may update the authorization request message. For example, processing network 610 may indicate to other entities whether second transaction token 208A is verified. In some embodiments, the verification result may be included as an indicator in the authorization request message. Additionally, processing network 610 may de-tokenize second transaction token 208A and replace it with real account information of the user in the authorization request message. This enables authorization computer 612 to identify the user's account to utilize for the transaction. In some cases, processing network 610 may access databases (e.g., token database 470 and user account information database 480 in FIG. 4) to determine account information, such as an account number (e.g., PAN) associated with second transaction token 208A and retrieve the account information from the databases.

At step 629, processing network 610 may send the authorization request message to authorization computer 612. The authorization request message may be sent over any suitable communications network. The indicator indicating whether second transaction token 208A is verified may be sent with the authorization request message. In some cases, the indicator may be included in the authorization request message as described in step 628. In other cases, the indicator may not be included in the authorization request message and may be sent separately with the authorization request message.

At step 630, authorization computer 612 may determine whether the transaction may be authorized. In some embodiments, the determination may be made based on the indicator received indicating whether second transaction token 208A was verified by processing network 610. In some embodiments, authorization computer 612 may conduct further processing to determine whether the authorization transaction may be authorized. In some cases, authorization computer 612 may conduct fraud analyses on the user's account associated with the account number included in the authorization request message. The authorization computer 612 may also determine if there are sufficient funds or credit in the account to conduct the current transaction.

At step 631, authorization computer 612 may generate an authorization response message. The authorization response message may include the authorization result determined in step 630. In some cases, authorization computer 612 may also include information related to the fraud analyses in the authorization response message.

At step 632, authorization computer 612 may send the authorization response message to processing network 610. The authorization response message may be sent over any suitable communications network.

At step 633, processing network 610 may receive and update the authorization response message. In some embodiments, processing network 610 may re-tokenize the account information included in the authorization response message. For example, processing network 610 may determine second transaction token 208A associated with the account information (e.g., PAN) and replace the account information with second transaction token 208A in the authorization response message. This enables sensitive account information of the user to be hidden from other entities (e.g., transport computer 608, the resource provider, access device 604) that process the authorization response message. In some cases, processing network 610 may access databases (e.g., token database 470 and user account information database 480 in FIG. 4) to determine second transaction token 208A associated with the account information and retrieve the second transaction token 208A from the databases.

At steps 634 and 635, the authorization response message may be transmitted from processing network 610 to transport computer 608 and from transport computer 608 to access device 604, respectively. The authorization response message may be communicated over any suitable communications network. In some embodiments, the resource provider computer may receive the authorization response message from transport computer 608. The resource provider associated with access device 504 and the resource provider computer may determine whether to allow the transaction to continue based on the information in the received authorization response message. If the resource provider decides to approve the transaction, the transaction may be authorized and completed. A transaction amount associated with the transaction may be debited from the user's account associated with second transaction token 208A. In some cases, a notification may be displayed by access device 604 or may be sent to user device 602 indicating whether the transaction was successfully completed.

In some cases, at a later time (e.g., at the end of the day), a clearing and settlement process can occur between transport computer 608, processing network 610, and authorization computer 612.

While the embodiments described above with respect to FIG. 5 and FIG. 6 describe conducting card-present transactions by interacting with and access device, embodiments are not so limited. In some embodiments, there may be exception cases in which transaction tokens meant to be utilized in card-present transaction channels may not be able to be processed. For example, a situation may arise in which the access device may not be able to process first payment token 204A or second payment token 208A during a card-present transaction for any reason (e.g., faulty access device, connection, etc.). In such a situation, a clerk at the payment terminal of the resource provider associated with the access device may instead key-enter third payment token 210 displayed on the user device to conduct the transaction. The authorization request message may be generated such that it includes information indicating that third payment token 210, which may typically be utilized in an e-commerce transaction channel, is instead being utilized in a card-present transaction for this exception case. The payment processing network may verify this information, or send it to the authorization computer for verification, and the transaction may be authorized based on the verification result.

Allowing such exception cases enables transaction processing to be more flexible. If third payment token 210 is utilized in a card-present transaction, the resource provider or other entities (e.g., processing network, authorization computer) may decide to conduct extra checks to determine whether the user utilizing the user device may be authenticated. This can ensure that a non-fraudulent transaction comprising key-entering third payment token 210 at the payment terminal of merchant 106 may not be universally declined in such exception cases.

Further, while the embodiments described above with respect to FIG. 5 and FIG. 6 show implementations in which each transaction token of the user device is designated to be utilized in a single transaction channel, embodiments are not so limited. This is because in some cases, a transaction token may be designated for use in a plurality of transaction channels. Exemplary transaction channels for a transaction may include a contact transaction channel (which may be further split into a magnetic stripe transaction and a contact chip transaction), a contactless transaction channel, an e-commerce transaction channel, a card-present transaction channel, a card-not-present transaction channel, a mail order transaction channel, and a telephone order transaction channel. In one exemplary case, third transaction token 210 may be designated to be utilized in an e-commerce transaction channel, a telephone order transaction channel, and a mail order transaction channel. In some cases, other transaction tokens on transaction card 200 including first transaction token 204A, second transaction token 208A, and fourth transaction token 214A may not be able to be utilized in these transaction channels.

Although the embodiments described above with respect to FIG. 5 and FIG. 6 detail the user device as a transaction card, embodiments are not so limited. For example, the user device may instead be a mobile phone, such as mobile phone 300 shown in FIG. 2. Transactions conducted using mobile phone 300 may be processed in a similar manner to that described for transaction card 200. Mobile phone 300 may comprise multiple transaction tokens associated with an account of the user, where each transaction token is designated to be utilized for a transaction in a different transaction channel. For example, first payment token 304A may be designated for in-app transactions, second payment token 308A may be designated for contactless transactions (e.g., PayWave™), and third payment token 310 may be designated for e-commerce transactions. The payment processing network may be capable of determining whether the transaction token utilized for the transaction is being utilized in an appropriate transaction channel based on a transaction channel identifier, cryptogram or other information, and allow the transaction to proceed based on the determination.

Embodiments of the invention may provide a number of advantages. For example, the probability that a compromised transaction token taken from a user device is utilized for cross-channel fraud can be reduced. This is because there are multiple transaction tokens stored on the user device and each transaction token may be designated for use in a specific transaction channel. Thus, for example, if a malicious party were to attempt to utilize stolen data including a transaction token associated with a card-present transaction channel either by copying data from the user device or taking data stored by an entity (e.g., from POS terminal computer systems), they would not be able to utilize the transaction token in a card-not-present transaction (e.g., e-commerce environment). The transaction would be rejected and fraud may be prevented.

Additionally, embodiments of the invention avoid unnecessary processing of fraudulent transactions. This is because transactions committing cross-channel fraud can be detected and terminated before further processing of the fraudulent transactions can be performed. For example, the processing network may receive and process the authorization request message and determine that the transaction token included in the authorization request message is being utilized in an inappropriate transaction channel (e.g., transaction token from magnetic-stripe being utilized in e-commerce transaction channel). Processing network may terminate the transaction and consequently forgo de-tokenization and re-tokenization processes (including data access retrieval processes from databases), authorization message modification processes, authorization determination processing, fraud analyses processing, and generation and transmission of an authorization response message. This reduces overall use of computing resources for processing of transactions and enables the computer system to run more efficiently as a whole.

Another advantage is that users may not have to perform cumbersome processes to set up their tokens. For example, typically, a user may have to input information into a user interface to associate a token with certain properties. In some cases, the user may manage multiple tokens that are associated with multiple accounts, further complicating token management. However, embodiments of the invention forgo these processes, since the user device can be created such that it is provisioned with multiple transaction tokens associated with a single account of the user and designated to an appropriate transaction channel.

Further, each transaction token may be stored in a different memory unit or location (e.g., printed on substrate). This avoids the case in which the same transaction token is stored in multiple memory units associated with different transaction channels, which may increase the number of transaction channels from which the transaction token can be stolen and utilized in cross-channel fraud. Embodiments of the invention allow the user to utilize a wider range of transaction channels to perform transactions, while reducing the risk of cross-channel fraud. Thus, embodiments of the invention provide more flexibility without compromising security.

FIG. 7 shows an exemplary authorization request message 700 according to embodiments of the invention. In some embodiments, authorization request message 700 may include a transaction token 701, an expiration date 702 (e.g., PAN expiration date), a transaction channel identifier 703, a token requestor identifier 704, resource provider data 705, a CVV 706, a cryptogram 707, a non-transactable payment account identifier 708 (PAID), and additional data 709. In some cases, the transaction channel identifier may also be known as the POS entry mode. In some cases the CVV may be a dynamic CVV. While FIG. 7 shows one exemplary authorization request message, it is understood that the authorization request message may include fewer or more elements than depicted by authorization request message 700.

The non-transactable payment account identifier 708 (PAID) may be any string of characters that identify an accountholder and that is not used to conduct a payment transaction on an underlying account. The non-transactable payment account identifier 708 enables entities such as resource providers and transport computers to identify accountholders when using transaction tokens for various applications. Such applications include, but are not limited to: fraud and risk checks on transaction authorization requests, fraud and risk reviews after transactions are completed, performance of value added services (e.g., loyalty, backend applications, reporting), and transaction feeds for third party value added applications.

The non-transactable payment account identifier 708 (PAID) can allow resource providers to track user spending habits, analyze fraud/risk, provide transaction feeds to third party applications, etc. without requiring sensitive payment account information, such as a PAN. Instead of tracking a user's account by several transaction tokens (e.g., associated with different transaction channels), which can potentially leading to multiple detached records for one user, the resource provider (or other entity) may be able to aggregate all transaction token spending records to the corresponding single account of the user via the non-transactable payment account identifier. Thus, transaction tokens may be utilized to make a user's account information more secure without interfering with a resource provider's programs. Further details regarding the non-transactable payment account identifier can be found in U.S. Non-provisional application Ser. No. 14/597,072, “Payment Account Identifier System,” which is hereby incorporated by reference in its entirety for all purposes.

Additional data 709 may be any information that may be utilized by entities when processing authorization request message 700. For example, additional data 709 may comprise a dollar amount value of the transaction, user identification data (e.g., name), and other information. In some cases, the resource provider computer associated with the access device may define the dollar amount value associated with the transaction and then include the dollar amount value in authorization request message 700 as part of additional data 709. Any of additional data 709 may provide the processing network and the authorization computer with additional information that can be utilized for fraud models, which may enable greater security for transactions.

A computer system may be utilized to implement any of the entities or components described above. Subsystems of the computer system may be interconnected via a system bus. Additional subsystems may include a printer, a keyboard, a fixed disk (or other memory comprising computer readable media), a monitor, which is coupled to a display adapter, and others. Peripherals and input/output (I/O) devices, which couple to an I/O controller (which can be a processor or other suitable controller), can be connected to the computer system by any number of means known in the art, such as by a serial port. For example, the serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk may embody a computer readable medium. In some embodiments, the monitor may be a touch sensitive display screen.

A computer system can include a plurality of the same components or subsystems, e.g., connected together by external interface or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed:

1. A user device comprising:
a substrate;
a first memory unit coupled to the substrate comprising a first transaction token to be utilized in a first transaction channel and associated with an account identifier for an account of a user; and
a second memory unit coupled to the substrate comprising a second transaction token to be utilized in a second transaction channel and associated with the account identifier for the account of the user, wherein the first and second transaction channels are distinct.

2. The user device of claim 1, wherein the user device is a transaction card, the first memory unit is a magnetic stripe, the first transaction channel is a contact transaction channel, the second memory unit is a memory chip, and the second transaction channel is a contactless transaction channel.

3. The user device of claim 1, wherein the user device is a mobile phone.

4. The user device of claim 3, wherein the first transaction channel is an in-app transaction channel and the second transaction channel is a contactless transaction channel.

5. The user device of claim 1, further comprising:
a third transaction token associated with the account identifier for the account of the user displayed on the substrate to be utilized in a third transaction channel, wherein the first, second, and third transaction channels are distinct.

6. The user device of claim 1, further comprising:
the account identifier for the account of the user displayed on the substrate to be utilized in a third transaction channel, wherein the third transaction channel is distinct from the first transaction channel and the second transaction channel.

7. The user device of claim 5, wherein the third transaction channel is a card-not-present transaction channel.

8. A method for using a user device comprising a first memory unit comprising a first transaction token and a second memory unit comprising a second transaction token, the first and second transaction tokens associated with an account identifier for an account of the user, the method comprising:
receiving, by a server computer, a first authorization request message including the first transaction token;
determining, by the server computer, that the first transaction token was utilized in a first transaction channel;
sending, by the server computer, an indication that the first transaction token is verified with the first authorization request message;
receiving, by the server computer, a second authorization request message including the second transaction token;
determining, by the server computer, that the second transaction token was utilized in a second transaction channel, wherein the first and second transaction channels are distinct; and
sending, by the server computer, an indication that the second transaction token is verified with the second authorization request message.

9. The method of claim 8, wherein the user device is a transaction card, the first memory unit is a magnetic stripe, the first transaction channel is a contact transaction channel, the second memory unit is a memory chip, and the second transaction channel is a contactless transaction channel.

10. The method of claim 8, wherein the user device is a mobile phone.

11. The method of claim 8, wherein the first transaction channel is an in-app transaction channel and the second transaction channel is a contactless transaction channel.

12. The method of claim 8, wherein the user device further comprises a third transaction token associated with the account identifier for the account of the user displayed on the substrate to be utilized in a third transaction channel, wherein the first, second, and third transaction channels are distinct.

13. The method of claim 8, wherein the user device further comprises the account identifier for the account of the user displayed on the substrate to be utilized in a third transaction channel, wherein the third transaction channel is distinct from the first transaction channel and the second transaction channel.

14. The method of claim 12, wherein the third transaction channel is a card-not-present transaction channel.

15. A server computer comprising:
a processor; and
a computer-readable medium coupled to the processor, the computer-readable medium comprising code, executable by the processor, for performing a method involving a user device comprising a first memory unit comprising a first transaction token and a second memory unit comprising a second transaction token, the first and second transaction tokens associated with an account identifier for an account of the user, the method comprising:
receiving a first authorization request message including the first transaction token;
determining that the first transaction token was utilized in a first transaction channel;
sending an indication that the first transaction token is verified with the first authorization request message;
receiving a second authorization request message including the second transaction token;
determining that the second transaction token was utilized in a second transaction channel, wherein the first and second transaction channels are distinct; and
sending an indication that the second transaction token is verified with the second authorization request message.

16. The server computer of claim 15, wherein the user device is a transaction card, the first memory unit is a magnetic stripe, the first transaction channel is a contact transaction channel, the second memory unit is a memory chip, and the second transaction channel is a contactless transaction channel.

17. The server computer of claim 15, wherein the user device is a mobile phone.

18. The server computer of claim 15, wherein the first transaction channel is an in-app transaction channel and the second transaction channel is a contactless transaction channel.

19. The server computer of claim 15, wherein the user device further comprises a third transaction token associated with the account identifier for the account of the user displayed on the substrate to be utilized in a third transaction channel, wherein the first, second, and third transaction channels are distinct.

20. The server computer of claim 19, wherein the third transaction channel is a card-not-present transaction channel.
